(19) United States
(12) Patent Application Publication
(10) Pub. No.: US 2022/0032514 A1
(43) Pub. Date: Feb. 3, 2022

(54) TOOL FOR OVER-MOULDING AND/OR BACK-MOULDING A CURVED GLASS BODY, AND METHOD FOR OVER-MOULDING AND/OR BACK-MOULDING A CURVED GLASS BODY

(71) Applicant: Volkswagen Aktiengesellschaft, Wolfsburg (DE)

(72) Inventors: Maik STRUBE, Eickhorst (DE); Volker WACHENSCHWAN, Schoeppenstedt (DE); Christine SCHUETZ, Braunschweig (DE); Wilma DEWALD, Braunschweig (DE)

(73) Assignee: Volkswagen Aktiengesellschaft, Wolfsburg (DE)

(21) Appl. No.: 17/499,538

(22) Filed: Oct. 12, 2021

Related U.S. Application Data
(63) Continuation of application No. PCT/EP2020/053247, filed on Feb. 10, 2020.

(30) Foreign Application Priority Data
Apr. 11, 2019 (DE) 10 2019 205 203.7

(51) Int. Cl. B29C 45/14

(52) U.S. Cl. CPC B29C 45/14221; B29C 45/14065; B29C 45/14434; B29K 2709/08; B29C 2045/14098; B29C 2045/14163; B29C 45/14778

(57) ABSTRACT

A tool for overmoulding and/or backmoulding a curved glass body is proposed, the tool having a first surface for supporting the curved glass body. The tool comprises a plurality of pins, the pins each having a first end face at a first end of the pins, and at least one section of the first surface being formed by the first end faces of the pins. The pins are mounted to be displaceable in their longitudinal direction so that at least the section of the first surface can be adapted to a contour of the curved glass body.

This nonprovisional application is a continuation of International Application No. PCT/EP2020/053247, which was filed on Feb. 10, 2020, and which claims priority to German Patent Application No. 10 2019 205 203.7, which was filed in Germany on Apr. 11, 2019, and which are both herein incorporated by reference.

### BACKGROUND OF THE INVENTION

### Field of the Invention

The present invention relates to a tool for overmoulding and/or backmoulding a curved glass body and to a method for overmoulding and/or backmoulding a curved glass body.

### Description of the Background Art

3D free-formed glass bodies will play an increasingly greater role in future vehicle interiors. Above all, they offer very high scratch and chemical resistance, can be coated or functionalized very easily, and can be integrated into elements such as displays, switches, and lighting elements.

In order to be able to fabricate components with glass surfaces in processes suitable for large-scale production, methods are necessary that connect the glass to the corresponding connecting elements within a short cycle time. The backmoulding or overmoulding of glass with plastic is an economical and effective alternative to gluing.

However, the imaging accuracy of 3D-shaped glass cannot be provided with precision on a large scale so as to ensure that it fits completely against an injection molding tool contour. In the prior art, cavities arise between the glass body and the tool into which the glass body is inserted. As soon as the plastic melt hits the glass, normally at very high pressures, breakage results if pressure peaks occur at certain points. This is particularly the case with planar shape deviations and bending radii other than those provided in the tool. A workpiece that is bent uniaxially with a fixed bending radius will have a hollow space if the radius is too small. If, in contrast, it is too large, the leg of the curved piece no longer rests against the tool if the concave side rests against the tool. The effect is the greater, the greater the distance between the bend axis and the edge of the tool.

### SUMMARY OF THE INVENTION

It is therefore an object of the present invention to provide a tool and a method for overmoulding and/or backmoulding a curved glass body, by means of which the overmoulding or backmoulding of the curved glass body is simplified, wherein breakage of the glass body can be prevented and costs can therefore be saved.

The aforementioned object is achieved by a tool for overmoulding and/or backmoulding a curved glass body, which tool has a first surface for supporting the curved glass body. The tool is designed in particular for producing a hybrid component comprising the curved glass body and preferably connecting elements. In particular, the hybrid component is a hybrid component for a vehicle, in particular a motor vehicle. The tool comprises a plurality of pins. The pins each have a first end face at a first end, at least one section of the first surface of the tool being formed by the first end faces of the pins. The pins in this case are mounted to be displaceable in their longitudinal direction so that at least the section of the first surface can be adapted to a contour of the curved glass body. Due to the adaptability, the tolerances of the glass body are compensated and thus glass breakage is prevented.

The glass body is in particular a three-dimensional glass body, in particular a 3D free-formed glass body. The glass body is not designed to be bendable. The glass body in particular has a preferably constant thickness of 0.1 mm to 7 mm, in particular 0.3 mm to 4 mm, most preferably between 0.7 mm and 2 mm. In particular, the glass body is made of soda-lime glass, aluminosilicate glass, borosilicate glass, or lithium-aluminum silicate glass, preferably uncured or chemically cured, and/or laminated glass.

The curved glass body has in particular at least one bend. The section of the first surface of the tool is associated in particular with a section of the glass body having a bend. In other words, the curved glass body is placed on the first surface such that at least one bend is arranged in the first section of the first surface. The term “contour” of the curved glass body refers in particular to a shape of the curved glass body surface that faces the first section. In other words, the shape of the surface of the tool in the section can thus adapt to the shape of the surface of the curved glass body and, in particular, reproduce it precisely.

The pins extend in particular in the longitudinal direction from a first end to a second end. The first end face is disposed at the first end. The first end faces together advantageously form a surface forming the section of the first surface. The pins are advantageously displaceable in their longitudinal direction such that their position adapts to the contour of a glass body, specifically such that the first end face of each pin rests on the surface of the glass body.

Because the pins are mounted to be displaceable and the section of the first surface can thus be adapted to a contour of an inserted curved glass body, the tool is designed to adapt to complex glass geometries, in particular also to unknown contours, of a curved glass body. In particular, the tool thus has a tool surface that is flexible in shape and can be precisely matched to the contour of a curved glass body. This avoids cavities and thus also pressure peaks when overmoulding and/or backmoulding the curved glass body. Overall, breakage of the glass body is thus avoided, wherein considerable costs are saved.

The choice of the size of the pins depends on the tolerances of the glass body and the complexity of the glass contour. The pins are preferably 4-edged pins. The pins can have a width which is at most 10 mm, in particular at most 8 mm, further preferably at most 6 mm. The width is to be understood as a dimension in a direction perpendicular to the longitudinal direction of the pins. Further, both dimensions can have an aforementioned width in both directions perpendicular to the longitudinal direction. In particular, the pins can have a square cross section, so that they have the aforementioned width in two dimensions perpendicular to the longitudinal direction.

The particularly small design of the pins ensures better adaptability and reproducibility of the curved glass body in the section of the first surface. In other words, because they are displaceable, the pins can fit precisely against the contour of the glass body, so that cavities are avoided during an injection molding process. In particular, the pins can be moved in their longitudinal direction such that the surface formed by their first end faces forms a flush curved surface which in particular reproduces the contour of the curved glass body in the section. For this purpose, the pins are arranged lined up in particular in rows and columns. In particular, the pins are arranged parallel to one another, their longitudinal direction corresponding in particular to a depth direction of the tool.

The pins are advantageously mounted by means of springs and/or air cushions. In particular, the pins are each mounted at their second ends by means of a spring and/or an air cushion. As a result of this mounting, they are designed accordingly to be displaceable in the longitudinal direction. In particular, the springs can be pretensioned. In particular, the springs are pretensioned by at least 0.5 mm, further preferably at least 1 mm, most preferably by about 2 mm.

Advantageously, the pins can be locked so that, in a state adapted to the contour of the glass body, the pins can serve as a particularly rigid support for the glass body during an injection molding process for overmoulding and/or backmoulding. In other words, the pins are fixable so that moving in the longitudinal direction is no longer possible. After locking, the pins no longer yield in the longitudinal direction. The glass body can thus be supported closely and fixedly, in particular during an injection molding process, so that breaks in the glass body are prevented.

The pins can advantageously be locked by means of lateral bracing. For this purpose, the tool has a clamping device, in particular in at least one direction of the pins, said direction being perpendicular to the longitudinal direction, in particular in both directions perpendicular to the longitudinal direction. The clamping device has at least one clamping screw which can press a piston against the pins in the lateral direction.

The tool is advantageously milled, in particular made of steel.

In a further aspect, the invention relates to a method for overmoulding and/or backmoulding a curved glass body, wherein the method comprises positioning the curved glass body on the first surface of the tool, wherein at least one section of the first surface is formed by end faces of pins of the tool. The positioning takes place in particular by means of a receiving device. For the temporary fixation of the glass body to the tool surface, a negative pressure can be applied in the tool.

In particular, the section of the first surface is adapted to a contour of the glass body. Specifically, a position of the pins in their longitudinal direction is adapted by moving the pins, so that the first surface corresponds at least in the section to a contour of the glass body. The adaptation can take place in particular mechanically, in particular by the mounting of the pins, said mounting being displaceable in the longitudinal direction, in particular by means of springs and/or air cushions. Due to the displaceable mounting of the pins, and in particular a pretensioning of the springs, the adaptation to the contour takes place automatically, so that each individual pin does not have to be aligned manually. This makes the method much more effective.

Further, the method comprises an injection molding process for overmoulding and/or backmoulding the glass body. Further, the injection molding process uses, in particular, a plastic melt temperature of at least 150° C., further preferably at least 175° C., most preferably at least 200° C. A flowable material in particular, comprising or consisting of a plastic material in particular (in other words a plastic melt), is introduced at the aforementioned temperature by means of the injection molding process. The flowable material is in particular a thermoplastic elastomer. In particular, it has 10% to 50% glass fiber reinforcement. In order to avoid process-related pressure peaks, the plastic melt can be provided with a certain gas charging, in particular by means of a chemical or physical blowing agent. The overmoulding and/or backmoulding serves in particular to connect the glass body to connecting elements.

In particular, the pins are locked after the adapting to the contour of the glass body and before the injection molding process is carried out, so that the pins serve as a support for the glass body during the injection molding process for overmoulding and/or backmoulding the glass body. This is done in particular by means of lateral bracing, which can preferably be done mechanically and/or hydraulically.

In particular, the method can comprise a presorting of glass bodies to be overmolded and/or backmolded, whereby the presorting takes place according to their contour, so that a batch-wise adaptation to their contour can take place. In particular, an adaptation to the contour can be controlled such that it takes place with each cycle and/or when the batch is changed.

In particular, the method is designed to produce a hybrid component, in particular for a vehicle, which comprises the curved glass body. In particular, the method is carried out by means of a tool described above.

In particular, the tool is designed to carry out a method of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a tool of the invention;

FIG. 2 is a perspective view of the pins of the tool of FIG. 1;

FIG. 3 is a plan view of the tool of the invention of FIG. 1;

FIG. 4 is a sectional view along the line A-A in FIG. 3; and

FIG. 5 is a process diagram of a method of the invention.

### DETAILED DESCRIPTION

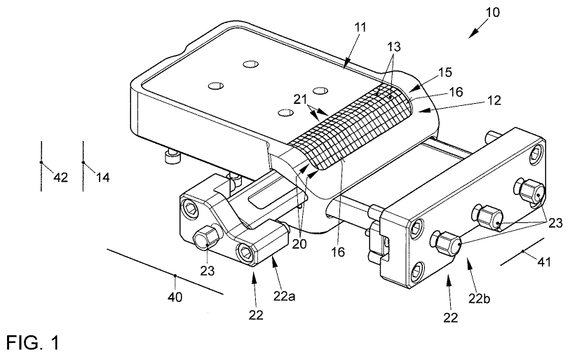

FIG. 1 shows a perspective view of a tool 10 of the invention. Tool 10 has a first surface 11 for supporting a curved glass body, which is to be overmolded and/or backmolded. Further, tool 10 comprises a plurality of pins 13. Each pin 13 has a first end 15 and a second end 18, wherein only first end 15 with its first end face 16 can be seen in the figure. Pins 13 are arranged lined up in rows 20 and columns. First end faces 16 of pins 13 form a surface 17 which forms a section 12 of first surface 11 of tool 10. Pins 13 are arranged such that their longitudinal direction 14 corresponds to depth direction 42 of tool 10. Further, tool 10 has a longitudinal direction 40 and a width direction 41.

Pins 13 are displaceable in longitudinal direction 14, so that their first end faces 16 can adapt to a contour of a glass body placed on first surface 11. In order to lock pins 13 in a state adapted to the contour, they can be clamped by means of clamping devices 22. Clamping devices 22 each have at least one clamping screw 23. In detail, tool 10 has a first clamping device 22a, which locks pins 13 in width direction 41 of tool 10, and a second clamping device 22b, which locks pins 13 in a longitudinal direction 40 of tool 10.

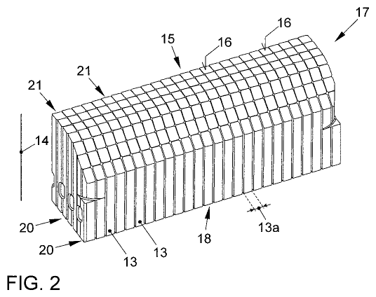

FIG. 2 shows a perspective view of pins 13 of tool 10 of FIG. 1. Pins 13 extend in longitudinal direction 14 from their first end 15 to second end 18. Each pin 13 has first end face 16 at first end 15. Further, a width 13a of pins 13 can be seen in FIG. 2.

Pins 13 are displaceable in longitudinal direction 14, so that their position can be adapted to the contour of a glass body such that first end face 16 of each pin 13 rests on the surface of the glass body. Pins 13 are thus designed to form a flush, curved surface 17, the contour of which is adapted to the contour of the curved glass body. Overall, pins 13 are arranged in 7 rows (20) and 26 columns (21).

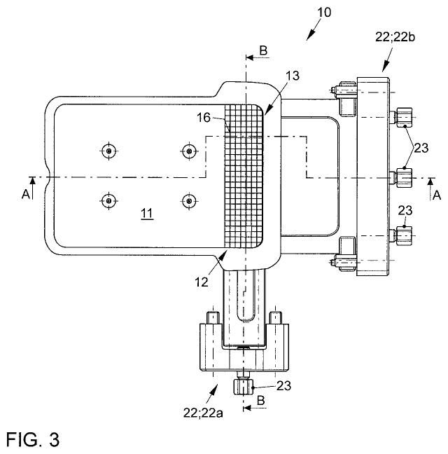

FIG. 3 shows a plan view of tool 10 of the invention from FIG. 1. It can be clearly seen how first end faces 16 of pins 13 form a section 12 of first surface 11 of tool 10. Section 12 is associated in particular with a curved section of the curved glass body which section is or is placed on first surface 11.

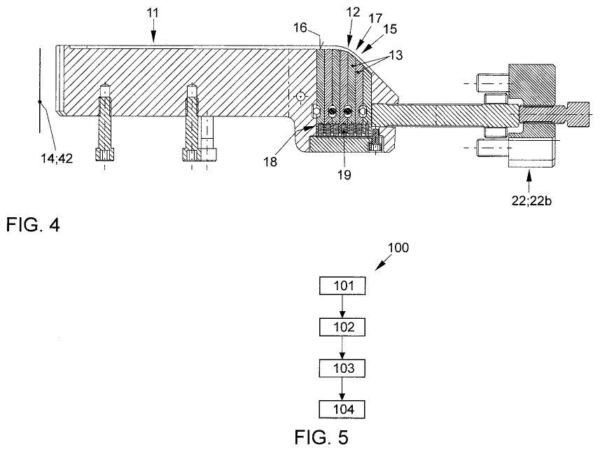

FIG. 4 shows a sectional view along the line A-A in FIG. 3. It can be clearly seen how pins 13 extend in longitudinal direction 14 from their second end 18 to first end 15. At second end 18, a spring 19 is disposed in each case, which is pretensioned and thus serves to make pins 13 displaceable so that their position can be adapted to the contour of a glass body placed thereon.

FIG. 5 shows a process diagram of a method 100 of the invention for overmoulding and/or backmoulding a curved glass body. Method 100 comprises the positioning 101 of the curved glass body on a first surface 11 of tool 10. At least one section 12 of first surface 11 is formed by end faces 16 of pins 13 of tool 10. For the temporary fixation of the glass body to the tool surface, a negative pressure can be applied in the tool.

Method 100 further includes adapting 102 section 12 to a contour of the glass body. For this purpose, the position of pins 13 is adapted by moving pins 13 in their longitudinal direction 14, so that first surface 11, at least in section 12, corresponds to a contour of the glass body.

Method 100 additionally comprises an injection molding process 104 for overmoulding and/or backmoulding the glass body. In injection molding process 104, tool 10 can be closed and a flowable molding compound, which is a plastic material (in other words, a plastic melt), can be injected so that the molding compound is distributed in the free space formed by closing the tool and completely fills the free space so as to at least partially coat the glass body with the compound. In order to avoid process-related pressure peaks, the plastic melt can be provided with a certain gas charging, in particular by means of a chemical or physical blowing agent.

In this way, a hybrid component can be produced that comprises the curved glass body. Further, the method can comprise locking 103 pins 13 after their position has been adapted to the contour of the glass body, so that pins 13 can serve as a support for the glass body during the injection molding process 104 and thus prevent breakage of the glass body.

What is claimed is:

1. A tool for overmoulding and/or backmoulding a curved glass body, the tool comprising:
a first surface to support the curved glass body; and
at least two pins, each having a first end face at a first end of the pins, at least one section of the first surface being formed by the first end faces of the pins,
wherein the at least two pins are mounted to be displaceable in their longitudinal direction so that at least the section of the first surface is adapted to a contour of the curved glass body.

2. The tool according to claim 1, wherein the at least two pins have a width that is at most 10 mm.

3. The tool according to claim 1, wherein the tool comprises a plurality of pins that are arranged lined up in rows and columns so that their first end faces form a flush curved surface when they are in the appropriate position in the longitudinal direction.

4. The tool according to claim 1, wherein the at least two pins have a second end, wherein the at least two pins are mounted at their second ends by springs and/or air cushions.

5. The tool according to claim 1, wherein the at least two pins are adapted to be locked so that, in a state adapted to the contour of the glass body, the pins serve as a support for the glass body during an injection molding process for overmoulding and/or backmoulding.

6. The tool according to claim 5, wherein the at least two pins are adapted to be locked by lateral bracing.

7. A method for overmoulding and/or backmoulding a curved glass body, the method comprising:
positioning the curved glass body on a first surface of a tool, wherein at least one section of the first surface is formed by end faces of pins of the tool;
adapting the section to a contour of the glass body by moving the pins in their longitudinal direction; and
carrying out an injection molding process for overmoulding and/or backmoulding the glass body.

8. The method according to claim 7, wherein the adapting takes place mechanically.

9. The method according to claim 7, wherein the pins are locked after the adapting to the contour of the glass body, so that the pins serve as a support for the glass body during the injection molding process for overmoulding and/or backmoulding the glass body.
